(19) United States
(12) Patent Application Publication
(10) Pub. No.: US 2006/0096621 A1
(43) Pub. Date: May 11, 2006

(54) Dishwasher having a drying apparatus

(75) Inventors: Yoon-sook Lee, Suwon-si (KR); Jae-ryong Park, Suwon-si (KR); Hyung-gyoon Kim, Suwon-si (KR); Byoung-yull Yang, Ansan-si (KR); Sang-yeon Pyo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Gyeonggi-do (KR)

(21) Appl. No.: 11/258,142

(22) Filed: Oct. 26, 2005

(30) Foreign Application Priority Data
Nov. 5, 2004 (KR) 10-2004-0089961

(51) Int. Cl. B08B 3/00

(52) U.S. Cl. 134/56 D; 134/95.2

(57) ABSTRACT

A dishwasher includes a main body provided with a wash tub for washing dishes and a drying apparatus having a drying duct provided with a through part communicating with the wash tub to draw in high temperature and humidity air from the wash tub, and a cold water tank contacting the drying duct to condense the high temperature and humidity air drawn into the drying duct.

### CROSS-REFERENCE TO RELATED APPLICATIONS

This application claims the benefit of Korean Patent Application No. 2004-0089961, filed on Nov. 05, 2004, in the Korean Intellectual Property Office, the disclosure of which is incorporated herein by reference.

### BACKGROUND OF THE INVENTION

1. Field of the Invention

The present invention relates to a dishwasher, and more particularly, to a dishwasher having a drying apparatus which condenses and dries high temperature and humidity air within a wash tub.

2. Description of the Related Art

Generally, a dishwasher refers to an apparatus that washes dishes by injecting high pressured water. The dishwasher comprises a main body having a wash tub accommodating the dishes, a wash apparatus supplying and discharging water to and from the wash tub for washing the dishes, and a drying apparatus for drying high temperature and humidity air within the wash tub by condensing the high temperature and humidity air to prevent the high temperature and humidity air of the wash tub from being discharged as it is.

Korea Utility Model First Publication No. 1998-0042323 discloses a dishwasher having the conventional drying apparatus. The conventional dishwasher is comprised of a ventilation part which is disposed between the wash tub and an outer case and draws in the high temperature and humidity air of the wash tub and outside air simultaneously, a drive part driving the ventilation part, and a guide part guiding water and air, which are drawn into the ventilation part and then condensed therein, to the wash tub.

The conventional dishwasher condenses the high temperature and humidity air discharged from the wash tub by the outside air and then provides back the wash tub with the condensed air to the wash tub.

However, the conventional dishwasher can have a low condensation efficiency depending on an outside condition because it condenses the high temperature and humidity air of the wash tub by the outside air only.

### SUMMARY OF THE INVENTION

Illustrative, non-limiting embodiments of the present invention overcome the above disadvantages as well as other disadvantages not described above.

Accordingly, it is an aspect of the present invention to provide a dishwasher having an improved condensation efficiency in condensing high temperature and humidity air of a wash tub.

Accordingly, an apparatus consistent with the present invention provides a dishwasher comprising a main body provided with a wash tub for washing dishes, a drying apparatus comprising a drying duct provided with a through part communicating with the wash tub to draw in high temperature and humidity air from the wash tub, and a cold water tank contacting the drying duct to condense the high temperature and humidity air drawn into the drying duct.

According to an embodiment of the present invention, the drying duct comprises at least one condensed water guide for guiding the condensed water condensed within the drying duct into the wash tub through the through part.

According to an embodiment of the present invention, the drying apparatus further comprises an air inlet part communicating with the drying duct, through which outside air flows into the drying duct.

According to an embodiment of the present invention, the main body comprises an inner casing forming the wash tub and an outer casing disposed outside of the inner casing, and the drying apparatus is disposed between the inner casing and the outer casing and in close contact with the inner casing.

According to an embodiment of the present invention, the cold water tank has therein a cold water supplier and a cold water discharger to supply and discharge cold water to and from the cold water tank.

According to an embodiment of the present invention, the dish washer further comprises a water supply pump supplying and injecting water into the wash tub, and wherein the cold water supplier is connected with the water supply pump and supplied with cold water therefrom.

According to an embodiment of the present invention, the cold water discharger discharges the cold water from the cold water tank in the case that a condensation process is finished and/or the case that the temperature of the cold water accommodated in the cold water tank rises up to a predetermined temperature.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a schematic sectional view of a dishwasher according to the present invention,

FIG. 2 is a perspective view of a drying apparatus of a dishwasher according to the present invention,

FIG. 3 is an exploded perspective view of a drying apparatus of a dishwasher according to the present invention,

FIG. 4 is a perspective view showing an operation of a drying apparatus of a dishwasher according to the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

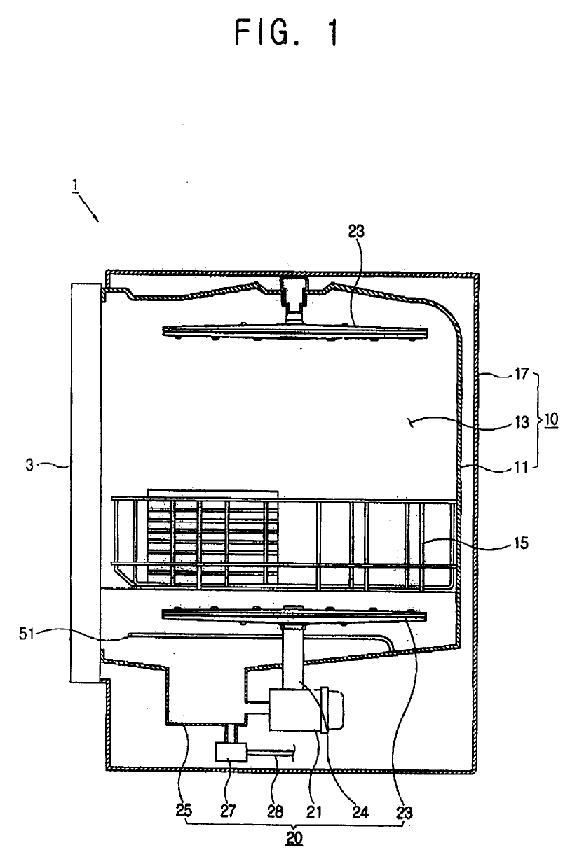

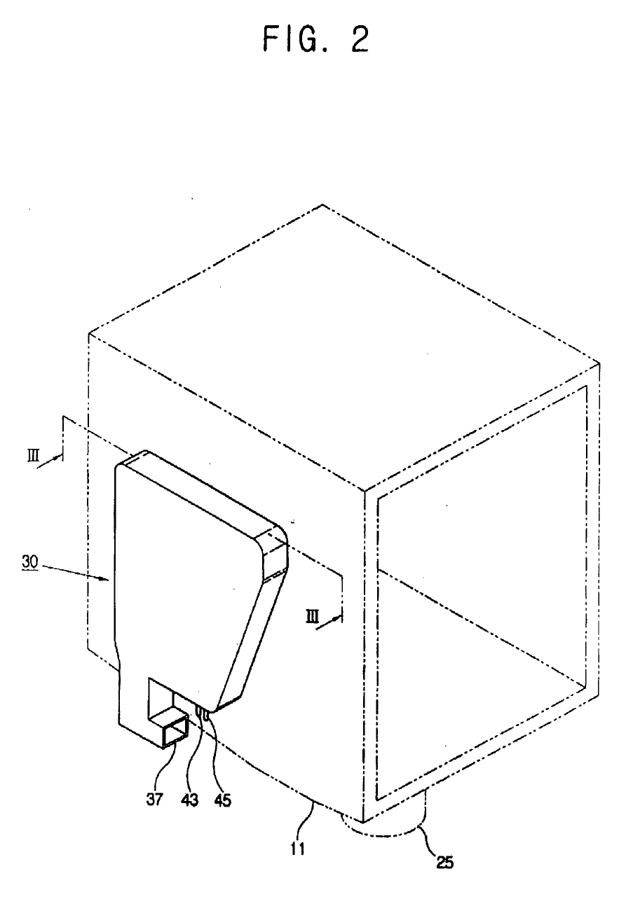

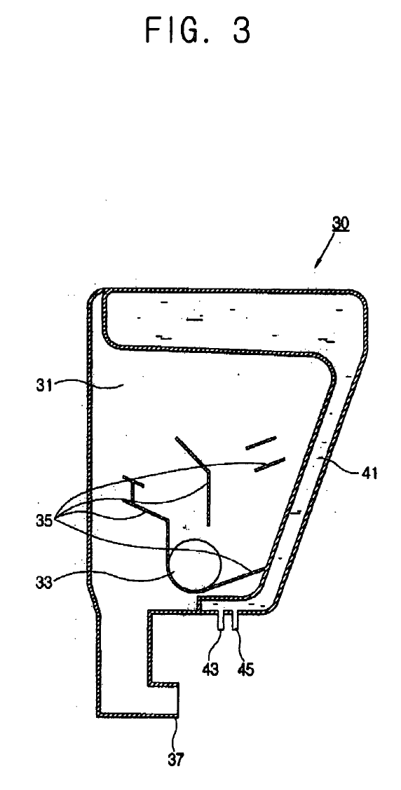

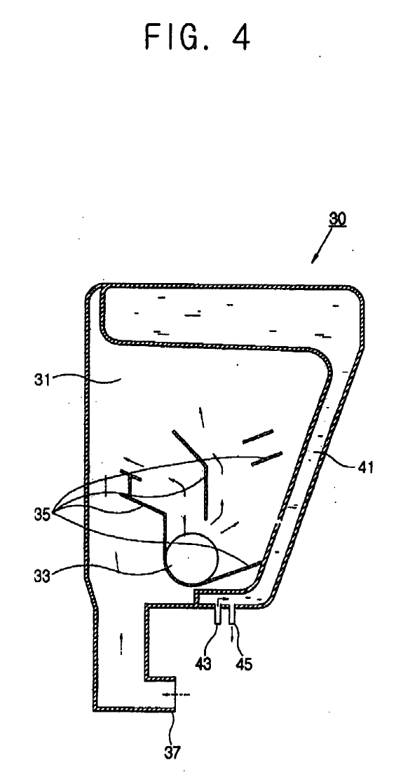

As shown in FIG. 1 through FIG. 4, a dishwasher 1 according to the present invention comprises: a main body 10 having therein a wash tub 13 accommodating dishes; a wash apparatus 20 supplying and discharging water to and from the wash tub 13 for washing the dishes; a drying apparatus 30 condensing and drying high temperature and humidity air of the wash tub 13 to prevent the high temperature and humidity air from being discharged as it is; a door 3 pivotably disposed on a front part of the main body 10.

The main body 10 comprises: an inner casing 11 forming the wash tub 13; and an outer casing 17 disposed on an outer side of the inner casing 11 and forming an external appearance of the dish washer 1.

The wash tub 13 is formed with the inner casing 11 and the door 3, and accommodates at least one dish basket 15 provided therein.

The wash apparatus 20 comprises: a wash nozzle 23 provided in the wash tub 13; a water supply pump 21 supplying water to the wash nozzle 23; a water collecting part 25 collecting used water; and a drain pump 27 discharging the collected used water in the water collecting part 25. Also, the wash apparatus 20 further comprises a heater 51 to heat the supplied water.

The wash nozzle 23 is connected with the water supply pump 21 and a supply pipe 24 through which the wash nozzle 23 is supplied with water from the water supply pump 21, and injects the water into the wash tub 13 to wash the dishes. The wash nozzle 23 is disposed in upper and lower parts of the wash tub 13, but it can be disposed in upper, lower, or side parts of the wash tub 13.

The water supply pump 21 supplies the wash nozzle 23 with the water provided from the outside. The water supply pump 21 is connected with the water collecting part 25, so that the water supply pump 21 can supply the water nozzle 23 with the water collected in the water collecting part 25. The water collecting part 25 is disposed in a lower part of the wash tub 13 to collect used water. The water collecting part 25 is connected with the water supply pump 21 so that the collected used water can be re-injected into the wash tub 13, and also the water collecting part 25 is connected with the drain pump 27 so that the collected used water can be discharged to the outside. In the water collecting part 25 can be provided a filter (not shown) so that food residues in the dishes can be filtered.

The drain pump 27 is connected with a drainage 28 so that the collected used water in the water collecting part 25 can be discharged to the outside when a dish wash process is finished or when it is needed.

The heater 51 is disposed in a lower part of the wash tub 13 so that it can heat the supplied water for washing with its body immersed in the supplied water. The heater 51 can heat the air within the wash tub 13 to dry the air after the dish wash and the drain are finished. The heating raises the temperature, humidity and pressure of the wash tub 13.

The drying apparatus 30 comprises: a drying duct 31 provided with a through part 33 penetratably connected with the wash tub 13 to draw in the high temperature and humidity air from the wash tub 13; and a cold water tank 41 contacting the drying duct 31 to condense the high temperature and humidity air drawn into the drying duct 31. The drying apparatus 30 can further comprise an air inlet part 37 penetratably connected with the drying duct 31, so that the outside air can flow into the drying duct 31. The drying apparatus 30 is disposed between the inner casing 11 and the outer casing 17 and in close contact with the inner casing 11. As examples of the present invention, the drying apparatus 30 is adhered or mounted on a side surface of the inner casing 11 or on a rear surface thereof.

The drying duct 31 is mounted on an outer surface of the inner casing 11, and the drying duct 31 has space therein so that the high temperature and humidity air can be drawn in from the wash tub 13 through the through part 33. The drying duct 31 comprises at least one condensed water guide 35 for guiding the condensed water condensed within the drying duct 31 to the wash tub 13 through the through part 33.

The through part 33 is disposed in a lower part of the drying duct 31 so that the drying duct 31 can be penetratably connected with the wash tub 13. The through part 33 functions as a passageway through which the high temperature and humidity air of the wash tub 13 can move to the drying duct 31. The high temperature and humidity air within wash tub 13 having a higher pressure than the drying duct 31 moves to the drying duct 31 through the through part 33 due to a pressure difference between the wash tub 13 and the drying duct 31. Also, the through part 33 functions as a passageway through which the condensed water within the drying duct 31 moves to the wash tub 13. The high temperature and humidity air moved to the drying duct 31 adheres on walls of the drying duct 31 which has a lower temperature than the wash tub 13 and becomes condensed thereon, thereby becoming the condensed water. Then the condensed water falls by its own weight and then flows into wash tub 13 through the through part 33.

The condensed water guide 35 guides the condensed water adhered on the walls of the drying duct 31 to flow into the through part 33, and for better efficiency the plural condensed water guides 35 can be disposed on the walls of the drying duct 31. Also, it is preferable that the plurality of the condensed water guides 35 be disposed on the walls of the drying duct 31 because the high temperature and humidity air can adhere to surfaces of the condensed water guide 35.

The cold water tank 41 needs to contact at least one part of the drying duct 31 to cool down the drying duct 31, and for better efficiency it is preferable that the cold water tank 41 contacts as many parts of the drying duct 31 as possible. For example, the cold water tank 41 can contact upper and side surfaces of the drying duct 31. However, the cold water tank 41 can contact another surface of the drying duct 31 to cool down the drying duct 31. In the cold water tank 41 are provided a cold water supplier 43 and a cold water discharger 45 to supply and discharge cold water to and from the cold water tank 41. The cold water tank 41 is in close contact with the inner casing 11 as the drying apparatus 30 is mounted on the inner casing 11, and cools down the inner casing 11, so that the high temperature and humidity air of the wash tub 13 can be adhered on walls of the inner casing 11 and then condensed, resulting in improving condensation efficiency.

The cold water supplier 43 is provided with water from the water supply pump 21 by being connected with it. However, the cold water supplier 43 can be provided with the water from a separate water supply pump.

The cold water discharger 45 discharges the water from the cold water tank 41 when the drying process is finished. The cold water discharger 45 also discharges the water when the temperature of the water accommodated in the cold water tank 41 rises up to a given temperature. The given temperature may be about 30° C. However, considering the configurations of the drying duct 31 and the cold water tank 41 and an outside temperature, etc., the given temperature may be from about 25° C. to about 35° C., or below 25° C. or above 35° C. The cold water discharger 45 can be connected with the drain pump 27 and discharges the water by employing the drain pump 27. The cold water discharger 45 also can discharge the water by employing a separate drain pump.

The air inlet part 37 is penetratably formed in the drying duct 31 so that the outside air can flow into the drying duct 31. The outside air flows into the drying duct 31 through the air inlet part 37 because the pressure in the drying duct 31 becomes relatively low during the time the high temperature and humidity air is condensed within the drying duct 31. Hence the high temperature and humidity air within the drying duct 31 can be condensed efficiently by being mixed with the outside air having a lower temperature than the air within the drying duct 31.

An operation process of the drying apparatus 30 of the dishwasher 1 according to the present invention will be described below.

First, water for washing is provided in the wash tub 13 and is heated by the heater 51 and then the wash apparatus 20 progresses its washing process. The heating of the heater 51 raises the temperature, humidity and pressure of the wash tub 13. When the washing and discharging process is finished, the high temperature and humidity air within the wash tub 13 moves to the drying duct 31, the pressure of which is relatively low, through the through part 33. The high temperature and humidity air moved to the drying duct 31 is condensed on the walls of drying duct 31 which is cooled down by the cold water of the cold water tank 41 and the condensed water guide 35. Moreover, the high temperature and humidity air moved to the drying duct 31 is also condensed by the outside air flowing into the drying duct 31 through the air inlet part 37. The condensed water is guided to the through part 33 by the condensed water guide 35 and moves to the wash tub 13 through the through part 33.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A dishwasher comprising:
a main body provided with a wash tub for washing dishes; and
a drying apparatus comprising a drying duct provided with a through part communicating with the wash tub to draw in high temperature and humidity air from the wash tub, and a cold water tank contacting the drying duct to condense the high temperature and humidity air drawn into the drying duct.

2. The dishwasher of claim 1, wherein the drying duct comprises at least one condensed water guide for guiding the condensed water condensed within the drying duct into the wash tub through the through part.

3. The dishwasher of claim 1, wherein the drying apparatus further comprises an air inlet part communicating with the drying duct, through which outside air flows into the drying duct.

4. The dishwasher of claim 1, wherein the main body comprises an inner casing forming the wash tub and an outer casing disposed outside of the inner casing, and the drying apparatus is disposed between the inner casing and the outer casing and in close contact with the inner casing.

5. The dishwasher of claim 1, wherein the cold water tank has therein a cold water supplier and a cold water discharger to supply and discharge cold water to and from the cold water tank.

6. The dishwasher of claim 5, further comprising a water supply pump supplying and injecting water into the wash tub, and wherein the cold water supplier is connected with the water supply pump and supplied with cold water therefrom.

7. The dishwasher of claim 5, wherein the cold water discharger discharges the cold water from the cold water tank when a condensation process is finished and/or when the temperature of the cold water accommodated in the cold water tank rises up to a predetermined temperature.
